(19) United States
(12) Patent Application Publication
(10) Pub. No.: US 2023/0002190 A1
(43) Pub. Date: Jan. 5, 2023

(54) INDICATION SYSTEM AND A METHOD FOR GENERATING AN INDICATION

(71) Applicant: KONE Corporation, Helsinki (FI)

(72) Inventors: Jussi LAURILA, Helsinki (FI); Visa RAUTA, Helsinki (FI)

(73) Assignee: KONE Corporation, Helsinki (FI)

(21) Appl. No.: 17/941,510

(22) Filed: Sep. 9, 2022

Related U.S. Application Data
(63) Continuation of application No. PCT/FI2020/050246, filed on Apr. 15, 2020.

(51) Int. Cl. B66B 3/00; B66B 1/46

(52) U.S. Cl. CPC B66B 3/002; B66B 1/468; B66B 2201/4638; B66B 2201/4676

(57) ABSTRACT

An indication system for generating an indication includes at least one indication device, at least one detection device configured to monitor at least one area inside a building to provide monitoring data, and a control unit. The control unit is configured to: detect based on the monitoring data obtained from the at least one detection device at least one predefined gesture of an identified user for which an elevator car (A-D) has been allocated, and control the at least one indication device to generate a visual indication on a floor of the building in a vicinity of the identified user in response to the detection of the at least one predefined gesture of the identified user. A method for generating an indication is also disclosed.

### TECHNICAL FIELD

The invention concerns in general the technical field of visual indication. Especially the invention concerns systems for generating visual indication.

### BACKGROUND

Typically, when an elevator call is allocated for a user, the elevator call information, e.g. allocated elevator car and/or destination floor, is indicated for the user by means of, e.g. a display. However, the if the elevator call is allocated already when the user is on the way to the elevator, e.g. when the user accesses via an access control gate device, such as a security gate or turnstile, the user may forget the elevator call information before arriving to the elevator.

Thus, there is need to develop further solutions in order to improve the indication of elevator call information.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an indication system and a method for generating an indication. Another objective of the invention is that the indication system and the method for generating an indication enables an on-demand indication of information for a user.

The objectives of the invention are reached by an indication system and a method as defined by the respective independent claims.

According to a first aspect, an indication system for generating an indication is provided, wherein the indication system comprises: at least one indication device, at least one detection device configured to monitor at least one area inside a building to provide monitoring data, and a control unit configured to: detect based on the monitoring data obtained from the at least one detection device at least one predefined gesture of an identified user for which an elevator car has been allocated, and control the at least one indication device to generate a visual indication on a floor of the building in a vicinity of the identified user in response to the detection of the at least one predefined gesture of the identified user.

The operation of the at least one detection device may be based on object recognition or pattern recognition.

The monitored at least one area may comprise a lobby area of the building, a landing area on at least one floor of the building, and/or one or more other areas on at least one floor of the building.

The visual indication may comprise elevator car allocation information and/or destination guidance information.

Alternatively or in addition, the visual indication may be indicated during a predefined period of time or until a detection of a predefined second gesture of the identified user.

The monitoring may comprise tracking movements and gestures of the identified user within the at least one monitoring area.

Moreover, the control unit may further be configured to: detect based on the tracked movements of the identified user that the identified user exits the building, and generate an instruction to an elevator control system to cancel all existing elevator car allocations for said identified user.

Furthermore, the control unit may further be configured to control the at least one indication device to generate a visual indication on a floor of the building in a vicinity of the identified user, wherein the visual indication may comprise an elevator car allocation cancel information.

According to a second aspect, a method for generating an indication is provided, wherein the method comprising: monitoring, by at least one detection device, at least one area inside a building to provide monitoring data; detecting, by a control unit, based on the monitoring data obtained from the at least one detection device at least one predefined gesture of an identified user for which an elevator car has been allocated; and controlling, by the control unit, at least one indication device to generate a visual indication on a floor of the building in a vicinity of the identified user in response to a detection of the at least one predefined gesture of the identified user.

The operation of the at least one detection device may be based on object recognition or pattern recognition.

The monitored at least one area may comprise a lobby area of the building, a landing area on at least one floor of the building, and/or one or more other areas on at least one floor of the building.

The visual indication may comprise elevator car allocation information and/or destination guidance information.

Alternatively or in addition, the visual indication may be indicated during a predefined period of time or until a detection of a predefined second gesture of the identified user.

The monitoring may comprise tracking movements and gestures of the identified user within the at least one monitoring area.

Moreover, the method may further comprise: detecting, by the control unit, based on the tracked movements of the identified user that the identified user exits the building; and generating, by the control unit, an instruction to an elevator control system to cancel all existing elevator car allocations for said identified user.

Furthermore, the method may further comprise controlling, by the control unit, the at least one indication device to generate a visual indication on a floor of the building in a vicinity of the identified user, wherein the visual indication may comprise an elevator car allocation cancel information.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example environment according to the invention, wherein different embodiments according to the invention may be implemented.

FIGS. 2A and 2B illustrate schematically example situations according to the invention.

FIG. 3 illustrates schematically an example of a method according to the invention.

FIG. 4 illustrates schematically an example of components of a control unit according to the invention.

### DESCRIPTION OF THE EXEMPLIFYING EMBODIMENTS

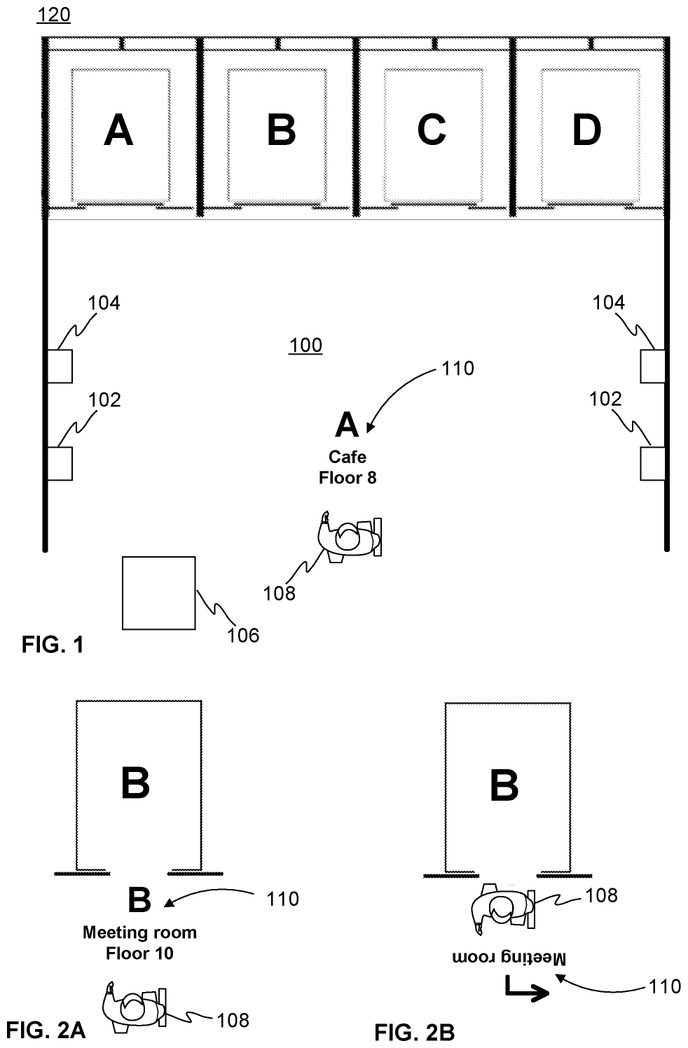

FIG. 1 illustrates schematically an example environment according to the invention, wherein an indication system 100 according to the invention may be implemented. The example environment is an elevator environment, i.e. an elevator system 120. The elevator system 120 may comprise at least two elevator cars A-D each travelling along a respective elevator shaft, an elevator control system (for sake of clarity not shown in FIG. 1), and the indication system 100 according to the invention. The elevator control system may be configured to control the operations of the elevator system 120, e.g. generate elevator call(s) to allocate the elevator cars A-D. The elevator control system may locate in a machine room of the elevator system 120 or in one of landings.

The indication system 100 comprises at least one detection device 102 for providing monitoring data, at least one indication device 104, and a control unit 106. The control unit 106 may be external entity or it may be implemented as a part of one or more other entities of the indication system 100. In the example of FIG. 1, the control unit 106 is an external entity. The external entity herein means an entity that locates separate from other entities of the indication system 100. The implementation of the control unit 106 may be done as a standalone entity or as a distributed computing environment between a plurality of stand-alone devices, such as a plurality of servers providing distributed computing resource. The control unit 106 may be configured to control the operations of the indication system 100. The control unit 106 may be communicatively coupled to at least one detection device 102, the at least one indication device 104, and any other entities of the indication system 100. The communication between the control unit 106 and the other entities of the indication system 100 may be based on one or more known communication technologies, either wired or wireless.

The at least one detection device 102 is configured to monitor at least one area inside a building in order to provide the monitoring data. The monitored at least one area may comprise e.g. a lobby area of the building, a landing area on at least one floor of the building, and/or one or more other areas, e.g. corridors or rooms, on at least one floor of the building. In the example of FIG. 1 the monitored area is a lobby area of the building, wherein the elevators A-D are located. In the example of FIG. 1 the indication system 100 comprises two detection devices 102 arranged within the elevator lobby area so that the two detection devices 102 are capable to monitor the elevator lobby area. However, the invention is not limited to that and the indication system 100 may comprise any other number of detection devices 102. For example, if the at least one monitoring area comprises alternatively or in addition the landing area on at least one floor of the building, the indication system 100 may comprise at least one detection device 102 arranged within the landing area on the at least one floor of the building to be able to monitor the landing area on the at least one floor of the building.

The at least one detection device 102 may comprise at least one optical imaging device, e.g. at least one camera. The at least one detection device 102 may enable detection, tracking, and/or identification of a user 108 at a distance away from the at least one detection device 102. The distance may be e.g. between 0 to 10 meters from the at least one detection device 102 and preferably between 1 to 2 meters, 1 to 3 meters or 1 to 5 meters. The at least one detection device 102 may be arranged to a wall, a ceiling and/or to a separate support device arranged within the at least one monitored area. In the example of FIG. 1, the two detection devices 102 are arranged to opposite walls of the elevator lobby area. According to an example embodiment of the invention the operation of the at least one detection device 102 may be based on object recognition or pattern recognition.

The at least one detection device 102 is configured to provide the monitoring data to the control unit 106. The control unit 106 is configured to detect at least one predefined gesture of an identified user 108 for which an elevator car A-D has been allocated. The allocation of an elevator car A-D for the user 108 and the identification of the user 108 may be provided by any known methods. Preferably, the allocation of the elevator car for the user 108 and the identification of the user 108 is provided already, when the user 108 is on the way to the elevator A-D, e.g. when the user 108 accesses the building or when the user passed through an access control gate device, such as a security gate. The access control gate devices allow access of identified authorized users through the access control gate device. The access control may be based on using keycards; tags; identification codes; e.g. PIN code, ID number, barcodes, QR codes, etc.; and/or biometric technologies, e.g. fingerprint, facial recognition, iris recognition, retinal scan, voice recognition, etc. The access control gate device may be communicatively coupled to the elevator control system enabling the elevator car allocation for the identified user 108 in response to the identification of an authorized user 108. The control unit 106 of the indication system 100 may obtain the elevator car allocation information and destination guidance information from the access control gate device, the elevator control system, and/or a database to which the elevator car allocation information and destination guidance information are stored.

The detection of the at least one predefined gesture of the identified user is based on the monitoring data obtained from the at least one detection device 102. The control unit 106 may utilize machine vision in the detection of the at least one predefined gesture. The predefined gestures of the identified user 108 may e.g. comprise, but is not limited to, lower a look in front of feet, a wave of hand, a toss of head, or any other gesture of the user 108.

The control unit 106 is configured to control the at least one indication device 104 to generate a visual indication 110 on a floor of the building in a vicinity of, i.e. close to, the identified user in response to the detection of the at least one predefined gesture of the identified user 108. For example, the visual indication 110 may be generated on the floor in front of the feet of the user 108 as shown in the example FIG. 1. The generated visual indication 110 may comprise elevator car allocation information and/or destination guidance information. The elevator car allocation information may comprise e.g. the allocated elevator car, destination floor, and/or destination place. The destination guidance information may comprise e.g. text- and/or figure-based guidance information. In the example of FIG. 1 the generated visual indication 110 comprises the allocated elevator car, i.e. the elevator car A, the destination floor, i.e. the floor 8, and the destination place, i.e. café. This enables an on-demand indication of the elevator car allocation information and/or destination guidance information for the user 108. Moreover, this enables for the user 108 an interference-free and hands-free way to check the elevator car allocation information and/or destination guidance information.

The at least one indication device 104 may comprise one or more projector devices configured to project the generated visual indication 110 on the floor in a vicinity of the identified user 108. In the example of FIG. 1 the indication system 100 comprises two indication devices 104 arranged within the elevator lobby area so that the two indication devices 104 are capable to generate the visual indication 110 on the floor within the elevator lobby area. However, the invention is not limited to that and the indication system 100 may comprise any other number of indication devices 104. For example, if the at least one monitoring area comprises alternatively or in addition the landing area on at least one floor of the building, the indication system 100 may comprise at least one indication device arranged also within the landing area on the at least one floor of the building to be able to generate the visual indication on the floor within the landing area on the at least one floor of the building. The at least one indication device 104 may be arranged to a wall, a ceiling and/or to a separate support device arranged within the at least one monitored area. In the example of FIG. 1, the two detection devices 102 are arranged to opposite walls of the elevator lobby area.

FIG. 2A illustrates a non-limiting example situation, wherein the control unit 106 is configured to control the at least one indication device 104 to generate the visual indication 110 on the floor in front of the feet of the identified user 108 in response to the detection of the at least one predefined gesture of the identified user 108 (for sake of clarity the control unit 106, the at least one indication device 104, and the at least one detection device 102 are not shown in FIG. 2A). In the example of FIG. 2A the identified user 108 is entering the elevator car B which has been allocated for said identified user 108. The generated visual indication 110 comprises the allocated elevator car, i.e. the elevator car B, the destination floor, i.e. the floor 10, and the destination place, i.e. a meeting room in the floor 10. FIG. 2B illustrates another non-limiting example situation, wherein the same identified user 108 arrives at the destination floor 10, exits the elevator car B, and performs the predefined gesture (for sake of clarity the control unit 106, the at least one indication device 104, and the at least one detection device 102 are not shown in FIG. 2B). The control unit 106 is configured to control the at least one indication device 104 arranged to the destination floor 10 to generate the visual indication 110 on the floor in front of the feet of the identified user 108 in response to the detection of the at least one predefined gesture of the identified user 108. The generated visual indication 110 comprises the destination place, i.e. the meeting room, and guidance information to the destination place. The guidance information comprises figure-based guidance information, e.g. the arrow in this example, to the destination place.

The visual indication 110 may be indicated during a predefined period of time. The predefined period of time may be such that the identified user 108 has time to see the visual indication, for example, but not limited to, the predefined period of time may be between 5 to 10 seconds. Alternatively, the visual indication 110 may be indicated until a detection of a predefined second gesture of the identified user 108. The predefined second gesture may be dependent on the previously detected predefined gesture and/or a counter gesture to the previously detected predefined gesture. According to an example, of the previously detected predefined gesture is lowering the look on the floor in front of his feet, the predefined second gesture of the identified user 108 may be raising the look from the floor. Alternatively, if the previously detected predefined gesture is a wave of hand or a toss of head, the predefined second gesture of the identified user 108 may be a wave of hand or a toss of head into another direction.

According to an example embodiment of the invention, the monitoring may comprise tracking movements and gestures of the identified user 108 within the at least one monitoring area. This enables tracking the movement of the identified user 108 within the monitoring area and every time the identified user 108 performs the predefined gesture, the control unit 106 may be configured to control the at least one indication device 104 to generate the visual indication on the floor in a vicinity of the identified user 108, e.g. in front of the identified user 108, irrespective of the location of the identified user 108 as long as the identified user 108 resides within the monitored area. This enables that the indication of the elevator car allocation information and/or destination guidance information may follow the user 108 to the destination of the user 108.

According to an example embodiment of the invention, the control unit 106 may further be configured to detect if the identified user 108 exits the building based on the tracked movements of the identified user 108. In response to the detection of the exit of the identified user 108, the control unit 106 may be configured to generate an instruction to the elevator control system to cancel all existing elevator car allocations for said identified user 108. This reduces amount of unnecessary elevator car allocations and thus improves the operation of the elevator system 120.

According to an example embodiment of the invention, in response to the cancelling the existing elevator car allocations for said identified user 108, the control unit 106 may further be configured to control the at least one indication device 104 to generate the visual indication 110 on the floor of the building in a vicinity of the identified user 108, e.g. in front if the identified user 108, wherein the generated visual indication comprises an elevator car allocation cancel information.

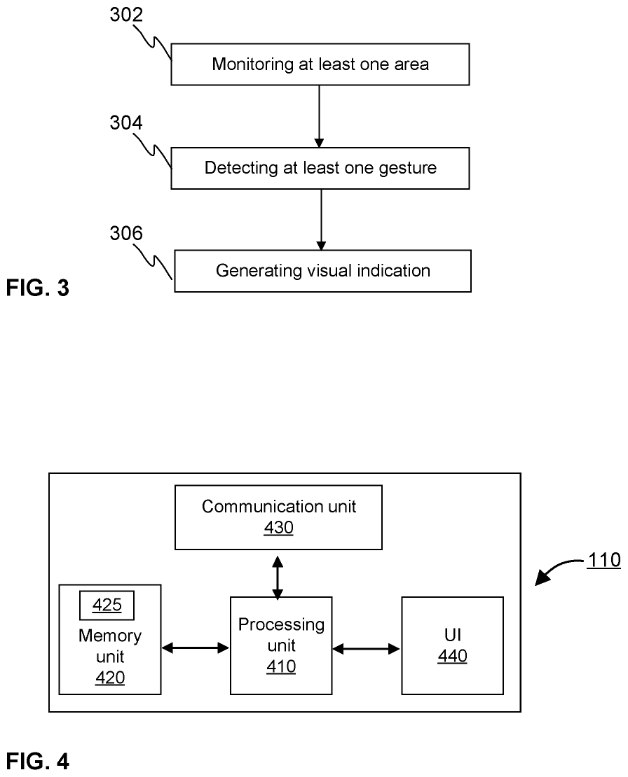

Next an example of the method according to the invention is described by referring to FIG. 3. FIG. 3 schematically illustrates the invention as a flow chart.

At a step 302, the at least one detection device 102 monitors at least one area inside the building in order to provide the monitoring data. The monitored at least one area may comprise e.g. a lobby area of the building, a landing area on at least one floor of the building, and/or one or more other areas, e.g. corridors or rooms, on at least one floor of the building. According to an example embodiment of the invention the operation of the at least one detection device 102 may be based on object recognition or pattern recognition. The at least one detection device 102 provides the monitoring data to the control unit 106.

At a step 304, the control unit 106 detects at least one predefined gesture of an identified user 108 for which an elevator car A-D has been allocated. The allocation of an elevator car A-D for the user 108 and the identification of the user 108 may be provided by any known methods as discussed above. The control unit 106 of the indication system 100 may obtain the elevator car allocation information and destination guidance information from the access control gate device, the elevator control system, and/or a database to which the elevator car allocation information and destination guidance information are stored. The detection of the at least one predefined gesture of the identified user is based on the monitoring data obtained from the at least one detection device 102. The control unit 106 may utilize machine vision in the detection of the at least one predefined gesture. The predefined gestures of the identified user 108 may e.g. comprise, but is not limited to, lower a look in front of feet, a wave of hand, a toss of head, or any other gesture of the user 108.

At a step 306, the control unit 104 controls the at least one indication device 104 to generate a visual indication 110 on a floor of the building in a vicinity of, i.e. close to, the identified user 108 in response to the detection of the at least one predefined gesture of the identified user 108. For example, the visual indication 110 may be generated on the floor in front of the feet of the user 108 as shown in the example FIG. 1. The generated visual indication 110 may comprise elevator car allocation information and/or destination guidance information. The elevator car allocation information may comprise e.g. the allocated elevator car, destination floor, and/or destination place. The destination guidance information may comprise e.g. text- and/or figure-based guidance information. This enables a simple way to indicate the elevator car allocation information and/or destination guidance information for the user 108. Moreover, this enables for the user 108 an interference-free and hands-free way to check the elevator car allocation information and/or destination guidance information.

The visual indication 110 may be indicated during a predefined period of time. The predefined period of time may be such that the identified user 108 has time to see the visual indication, for example, but not limited to, the predefined period of time may be between 5 to 10 seconds. Alternatively, the visual indication 110 may be indicated until a detection of a predefined second gesture of the identified user 108. The predefined second gesture may be dependent on the previously detected predefined gesture and/or a counter gesture to the previously detected predefined gesture. According to an example, of the previously detected predefined gesture is lowering the look on the floor in front of his feet, the predefined second gesture of the identified user 108 may be a raising the look from the floor. Alternatively, if the previously detected predefined gesture is a wave of hand or a toss of head, the predefined second gesture of the identified user 108 may be a wave of hand or a toss of head into another direction.

According to an example embodiment of the invention, the monitoring may comprise tracking movements and gestures of the identified user 108 within the at least one monitoring area. This enables tracking the movement of the identified user 108 within the monitoring area and every time the identified user 108 performs the predefined gesture, the control unit 106 may control the at least one indication device 104 to generate the visual indication on the floor in a vicinity of the identified user 108, e.g. in front of the identified user 108, irrespective of the location of the identified user 108 as long as the identified user 108 resides within the monitored area. This enables that the indication of the elevator car allocation information and/or destination guidance information may follow the user 108 to the destination of the user 108.

According to an example embodiment of the invention, the method may further comprise detecting, by the control unit 106, based on the tracked movements of the identified user 108, if the identified user 108 exits the building. In response to the detection of the exit of the identified user 108, the control unit 106 may generate an instruction to the elevator control system to cancel all existing elevator car allocations for said identified user 108. This reduces amount of unnecessary elevator car allocations and thus improves the operation of the elevator system 120.

According to an example embodiment of the invention, in response to the cancelling the existing elevator car allocations for said identified user 108, the method may further comprise controlling, by the control unit 106, the at least one indication device 104 to generate the visual indication 110 on the floor of the building in a vicinity of the identified user 108, e.g. in front if the identified user 108, wherein the generated visual indication comprises an elevator car allocation cancel information.

FIG. 4 schematically illustrates an example of components of the control unit 106 according to the invention. The control unit 106 may comprise a processing unit 410 comprising one or more processors, a memory unit 420 comprising one or more memories, a communication unit 430 comprising one or more communication devices, and possibly a user interface (UI) unit 450. The memory unit 420 may store portions of computer program code 425 and any other data, and the processing unit 410 may cause the control unit 106 to operate as described by executing at least some portions of the computer program code 425 stored in the memory unit 420. The communication unit 430 may be based on at least one known communication technologies, either wired or wireless, in order to exchange pieces of information as described earlier. The communication unit 430 provides an interface for communication with any external unit, such as the at least one indication device 104, the at least one detection device 102, the elevator control system, database and/or any external entities or systems. The communication unit 430 may comprise one or more communication devices, e.g. radio transceiver, antenna, etc. The user interface 440 may comprise I/O devices, such as buttons, keyboard, touch screen, microphone, loudspeaker, display and so on, for receiving input and outputting information. The computer program 425 may be stored in a non-statutory tangible computer readable medium, e.g. an USB stick or a CD-ROM disc.

The specific examples provided in the description given above should not be construed as limiting the applicability and/or the interpretation of the appended claims. Lists and groups of examples provided in the description given above are not exhaustive unless otherwise explicitly stated.

1. An indication system for generating an indication, wherein the indication system comprises:
at least one indication device,
at least one detection device configured to monitor at least one area inside a building to provide monitoring data, and
a control unit configured to:
detect based on the monitoring data obtained from the at least one detection device at least one predefined gesture of an identified user for which an elevator car (A-D) has been allocated, and
control the at least one indication device to generate a visual indication on a floor of the building in a vicinity of the identified user in response to the detection of the at least one predefined gesture of the identified user.

2. The system according to claim 1, wherein the operation of the at least one detection device is based on object recognition or pattern recognition.

3. The system according to claim 1, wherein the monitored at least one area comprises a lobby area of the building, a landing area on at least one floor of the building, and/or one or more other areas on at least one floor of the building.

4. The system according to claim 1, wherein the visual indication comprises elevator car allocation information and/or destination guidance information.

5. The system according to claim 1, wherein the visual indication is indicated during a predefined period of time or until a detection of a predefined second gesture of the identified user.

6. The system according to claim 1, wherein the monitoring comprises tracking movements and gestures of the identified user within the at least one monitoring area.

7. The system according to claim 6, wherein the control unit is further configured to:
detect based on the tracked movements of the identified user that the identified user exits the building, and
generate an instruction to an elevator control system to cancel all existing elevator car allocations for said identified user.

8. The system according to claim 7, wherein the control unit is further configured to control the at least one indication device to generate a visual indication on a floor of the building in a vicinity of the identified user, wherein the visual indication comprises an elevator car allocation cancel information.

9. A method for generating an indication, wherein the method comprising comprises:
monitoring, by at least one detection device, at least one area inside a building to provide monitoring data,
detecting, by a control unit, based on the monitoring data obtained from the at least one detection device at least one predefined gesture of an identified user for which an elevator car (A-D) has been allocated, and
controlling, by the control unit, at least one indication device to generate a visual indication on a floor of the building in a vicinity of the identified user in response to a detection of the at least one predefined gesture of the identified user.

10. The method according to claim 9, wherein the operation of the at least one detection device is based on object recognition or pattern recognition.

11. The method according to claim 9, wherein the monitored at least one area comprises a lobby area of the building, a landing area on at least one floor of the building, and/or one or more other areas on at least one floor of the building.

12. The method according to claim 9, wherein the visual indication comprises elevator car allocation information and/or destination guidance information.

13. The method according to claim 9, wherein the visual indication is indicated during a predefined period of time or until a detection of a predefined second gesture of the identified user.

14. The method according to claim 9, wherein the monitoring comprises tracking movements and gestures of the identified user within the at least one monitoring area.

15. The method according to claim 14, wherein the method further comprises:
detecting, by the control unit, based on the tracked movements of the identified user that the identified user exits the building, and
generating, by the control unit, an instruction to an elevator control system to cancel all existing elevator car allocations for said identified user.

16. The method according to claim 15, wherein method further comprises controlling, by the control unit, the at least one indication device to generate a visual indication on a floor of the building in a vicinity of the identified user, wherein the visual indication comprises an elevator car allocation cancel information.

17. The system according to claim 2, wherein the monitored at least one area comprises a lobby area of the building, a landing area on at least one floor of the building, and/or one or more other areas on at least one floor of the building.

18. The system according to claim 2, wherein the visual indication comprises elevator car allocation information and/or destination guidance information.

19. The system according to claim 3, wherein the visual indication comprises elevator car allocation information and/or destination guidance information.

20. The system according to claim 2, wherein the visual indication is indicated during a predefined period of time or until a detection of a predefined second gesture of the identified user.
